(19) United States
(12) Patent Application Publication
(10) Pub. No.: US 2024/0071648 A1
(43) Pub. Date: Feb. 29, 2024

(54) Integrated Power Supply DC Output Line

(71) Applicant: Cheng-Hui Huang, Kaohsiung City (TW)

(72) Inventors: Cheng-Hui Huang, Kaohsiung City (TW); Shuang Pi, Dongguan City (CN)

(21) Appl. No.: 18/338,677

(22) Filed: Jun. 21, 2023

(30) Foreign Application Priority Data
Aug. 23, 2022 (TW) 111209153

(51) Int. Cl. H01B 7/00; H01B 7/02

(52) U.S. Cl. CPC H01B 7/0045; H01B 7/02; H01R 25/003

(57) ABSTRACT

An integrated power supply DC output line serves as a power output line of a power supply unit and includes at least an integrated wire harness and a first connector. The integrated wire harness includes spaced first and second ends. The integrated wire harness is characteristic of the first end connected with the power supply unit for power receiving as well as the second end connected with a wire terminal from which the integrated wire harness is transformed to a plurality of leading wires. The integrated wire harness includes an insulating layer at an outermost layer thereof and a plurality of wires within the insulating layer. The first connector is electrically connected with the plurality of leading wires.

### BACKGROUND OF THE INVENTION

### 1. Field of the Invention

The present invention relates to a power supply output line and, more particularly, to an integrated power supply DC (direct current) output line.

### 2. Description of the Related Art

The power output line is a critical power supply part installed in a host computer and connected with and used in energizing a motherboard, a central processing unit, a VGA (Video Graphics Array) card, a hard drive and peripheral components. For normal running of a host computer, a plurality of extension ports are usually reserved on a host computer's motherboard for connections of a 24P (24 pin) wire harness for the motherboard, one or two wire harnesses for the central processing unit, 1˜16 ports on a wire harnesses for the PCI (Peripheral Component Interconnect) interface and a plurality of wire harnesses for hard drives and/or additional peripheral components to be energized later.

It has been known that a 24P connector at a wire harness is designed for power output to the motherboard. As shown in FIG. 2, a wire harness A1 consists of a plurality of core wires A2 arranged as a straight line, wherein each core wire A2 is coated with a protective layer A3 and two adjacent protective layers A3 are linked partially for development of a one-dimensional array. A wire harness for a motherboard includes 2328 electrical wires, a wire harness for a central processing unit (CPU) includes 4˜16 electrical wires, a wire harness for a VGA card includes 6N (N: positive integer) electrical wires, and a wire harness for a hard drive includes 4N electrical wires. A traditional power supply line is a heavy and costly component, and electrical wires packed into a host computer are criticized for poor cable management and electrical wires disorganized that occupy much space inside the host computer, obstruct airflows and significantly go against air cooling in the host computer. Particularly when the space of the host computer is not enough, it is necessary to reduce other hardware assembled in the host to place wire harnesses, which negatively affects the extension efficiency of the host computer.

### BRIEF SUMMARY OF THE INVENTION

Thus, an objective of the present invention is to provide an integrated power supply DC output line, which features wires centrally arranged as a polar array on the radial cross section.

To achieve this and other objectives, an integrated power supply DC output line according to an embodiment of the present invention serves as a power output line of a power supply unit and includes at least an integrated wire harness and a first connector. The integrated wire harness includes spaced first and second ends. The first end is connected with the power supply unit, and the second end is connected with a wire terminal from which the at least an integrated wire harness is transformed to a plurality of leading wires. The integrated wire harness includes an insulating layer at an outermost layer thereof and a plurality of wires within the insulating layer. The first connector is electrically connected with the plurality of leading wires.

In a preferred form, the plurality of wires includes a sheathed wire centrally inside the insulating layer and multiple unsheathed wires positioned between the insulating layer and the sheathed wire and based on equiangular arrangement around the sheathed wire circumferentially. The sheathed wire is coated with a protective layer outside and has a wire diameter greater than a wire diameter of the unsheathed wire.

In a preferred form, the plurality of wires includes a first unsheathed wire centrally inside the insulating layer, a plurality of sheathed wire positioned between the insulating layer and the first unsheathed wire, and multiple second unsheathed wires. The plurality of sheathed wire are based on equiangular arrangement around the contour of the first unsheathed wire circumferentially. Each second unsheathed wire is arranged between two adjacent sheathed wires and the insulating layer. The sheathed wire is coated with a protective layer outside and has a wire diameter greater than a wire diameter of each of the first and second unsheathed wires.

In a preferred form, the plurality of wires includes a plurality of sheathed wires positioned inside the insulating layer and arranged as a bundle. The sheathed wire is coated with a protective layer outside.

In a preferred form, the first end of the integrated wire harness is a power receiving terminal from which DC power input of the power supply unit is transmitted to the integrated wire harness, and the second end is a power transmitting terminal from which DC power output is transmitted to a facility connected with the second end.

In a preferred form, the first end of the integrated wire harness is directly connected with internal circuits of the power supply unit for power receiving.

In a preferred form, the power supply unit includes an output module socket, the first end of the integrated wire harness is plugged into the output module socket through a second connector for power receiving.

In a preferred form, the first connector is a 24P (pin) power connector to be connected with a computer motherboard, and the at least an integrated wire harness includes 8 to 13 integrated wire harnesses.

In a preferred form, the first connector is a power connector to be connected with a central processing unit, and the at least an integrated wire harness includes 1 to 4 integrated wire harnesses.

In a preferred form, the first connector is a power connector to be connected with a VGA card, and the at least an integrated wire harness includes 1 to 8 integrated wire harnesses.

In a preferred form, the first connector is a power connector to be connected with a hard drive, and the at least an integrated wire harness includes 2 to 15 integrated wire harnesses.

In a preferred form, the first connector is a 12+4P (pin) power connector for the PCIe 5.0 interface.

In a preferred form, the power supply unit is equipped with a plurality of output module sockets, and the first end of the integrated wire harness is plugged into a corresponding output module socket for power receiving through a plurality of second connectors which are 8P connectors for the PCIe interface.

In the present invention, the integrated power supply DC output line applicable to the host computer is characteristic of one end directly connected with internal circuits of a power supply unit for power receiving or plugged into an output module socket of the power supply unit through the second connector for transmissions of electricity to a 24P wire harness for a motherboard, a wire harness for a central processing unit, a wire harness for a VGA card and a wire harness for a hard drive, each of which is an output line or a plug-and-play harnesses inside the host computer. Accordingly, the wire wind resistance inside the host computer in which the integrated power supply DC output line is installed is greatly reduced for economy of materials, material cost reduction, improvement of production efficiency, less space occupation as well as user-friendly and simplified cable management inside the host computer, and good practical efficiency.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1A, FIG. 1B, FIG. 1C, FIG. 1D, FIG. 1E, and FIG. 1F are front views for six embodiments of an integrated power supply DC output line in accordance with the present invention, respectively.

FIG. 2 is a cross-sectional view for the structure of a traditional wire harness.

FIG. 3A is a sectional view taken along line A-A of FIG. 1A, illustrating an embodiment of an integrated wire harness according to the present invention.

FIG. 3B is a sectional view taken along line A-A of FIG. 1A, illustrating another embodiment of an integrated wire harness according to the present invention.

FIG. 3C is a sectional view taken along line A-A of FIG. 1A, illustrating a further embodiment of an integrated wire harness according to the present invention.

FIG. 4 is a left view of a 24P power connector for a computer motherboard in the embodiment of FIG. 1A.

FIG. 5 is a left view of a power connector for a central processing unit in the embodiment of FIG. 1B.

FIG. 6 is a left view of a power connector for a VGA card or display card in the embodiment of FIG. 1 C.

FIG. 7A is a left view of a power connector for a hard drive in the embodiment of FIG. 1D.

FIG. 7B is a left view of a power connector for a hard drive in the embodiment of FIG. 1E.

FIG. 8 is a left view of a 12+4P power connector for the PCIe 5.0 interface in the embodiment of FIG. 1F.

FIG. 9 is a front view for another embodiment of an integrated power supply DC output line in accordance with the present invention.

FIG. 10 is a right view of second connectors of the integrated power supply DC output line in FIG. 9.

### DETAILED DESCRIPTION OF THE INVENTION

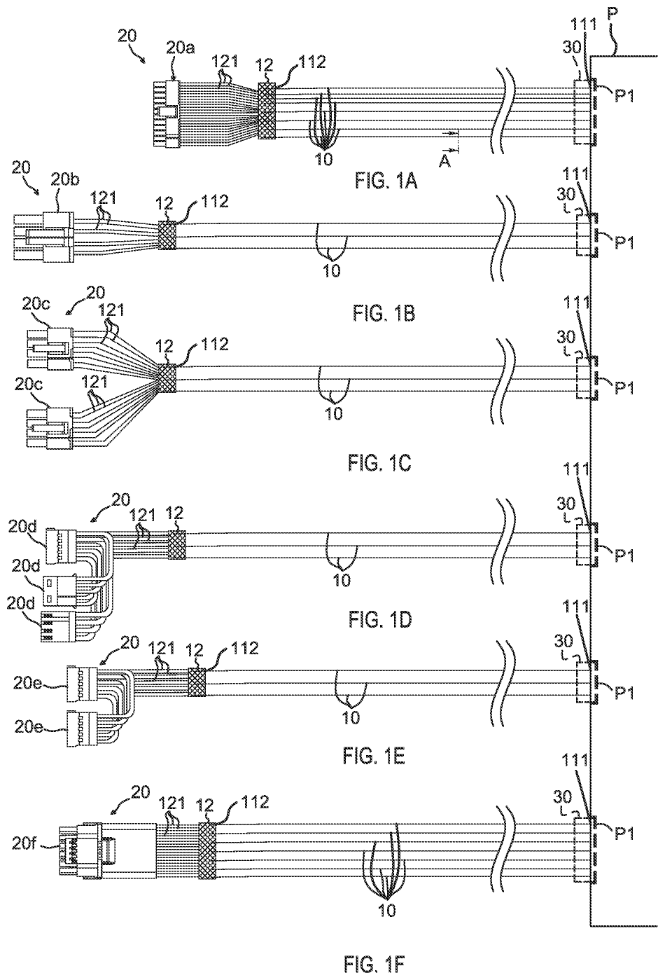

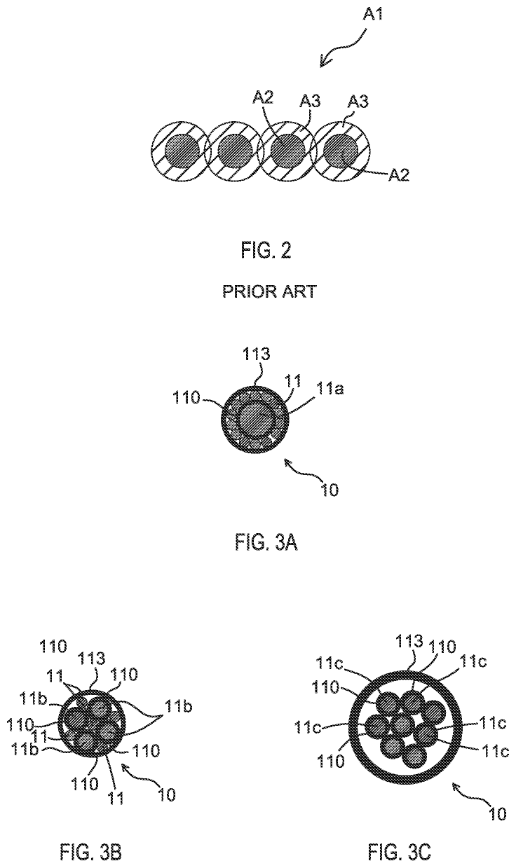

FIG. 1A, FIG. 1B, FIG. 1C, FIG. 1D, FIG. 1E, and FIG. 1F are front views for six embodiments of an integrated power supply DC (direct current) output line in accordance with the present invention, respectively. FIG. 3A is a sectional view taken along line A-A of FIG. 1A, illustrating an embodiment of an integrated wire harness according to the present invention. Referring to FIGS. 1A and 3, the integrated power supply DC output line of the present invention is applicable to a power supply unit P, for example, a power supplier from which output voltages are supplied to a host computer. The integrated power supply DC output line of the present invention is connected from the power supply unit P to inside of the host computer case in which hardware facilities are energized. The integrated power supply DC output line includes at least one integrated wire harness 10 and a first connector 20.

The integrated wire harness 10 includes a plurality of wires 11, 11a that are arranged as a specific pattern. The integrated wire harness 10 has a first end 111 and a second end 112, both of which are spaced from each other. The first end 111 is connected with the power supply unit P, and the second end 112 is connected with a wire terminal 12 from which the integrated wire harness 10 are transformed to a plurality of leading wires 121. The first connector 20 is electrically connected with the leading wires 121 and plugged into a corresponding slot (not shown in figures) on an electronic facility to be energized for transmission of electricity to the electronic facility.

As shown in FIG. 3A, a first embodiment of the integrated wire harness 10 of the present invention includes an insulating layer 113 at the outermost layer thereof, a sheathed wire 11a centrally inside the insulating layer 113, and a plurality of wires 11 positioned between the insulating layer 113 and the sheathed wire 11a and based on equiangular arrangement around the sheathed wire 11a circumferentially. From the view of a radial cross section, the wires 11 are arranged as a polar array. The sheathed wire 11a coated with a protective layer 110 outside features a wire diameter greater than that of the wire 11.

As shown in FIG. 3B, a second embodiment of the integrated wire harness 10 of the present invention includes an insulating layer 113 at the outermost layer thereof, a first wire 11 centrally inside the insulating layer 113, a plurality of sheathed wires 11b positioned between the insulating layer 113 and the first wire 11 and based on equiangular arrangement around the contour of the first wire 11 circumferentially, and a second wire 11 arranged between any two adjacent sheathed wires 11b and the insulating layer 113. The sheathed wire 11b coated with a protective layer 110 outside features a wire diameter greater than that of each of the first and second wires 11. In this embodiment, the integrated wire harness 10 includes four sheathed wires 11b and four second wires 11.

As shown in FIG. 3C, a third embodiment of the integrated wire harness 10 of the present invention includes an insulating layer 113 at the outermost layer thereof, and a plurality of sheathed wires 11c positioned inside the insulating layer 113 and arranged as a bundle. The sheathed wire 11c coated with a protective layer 110 outside. In this embodiment, one of the plurality of sheathed wires 11c is centrally inside the insulating layer 113, and the rest of the sheathed wires 11c are arranged around the sheathed wire 11c positioned at the center of the insulating layer 113.

As shown in FIG. 1A, the first end 111 of the integrated wire harness 10 is a power receiving terminal from which DC power input of the power supply unit P is transmitted to each integrated wire harness 10, and the second end 112 is a power transmitting terminal from which DC power output is transmitted to a facility connected with the second end 112.

Preferably, the first end 111 of the integrated wire harness 10 is directly connected with internal circuits of the power supply unit P for power receiving.

Preferably, the power supply unit P is equipped with at least an output module socket P1. For power receiving, the first end 111 of the integrated wire harness 10 is plugged into the output module socket P1 through a second connector 30 such that the function of modularized and customized electricity supply is effectuated. Moreover, unobstructed internal airflows for good air cooling inside a host computer are maintained when an output module socket P1 with which no integrated power supply DC output line is connected is removed.

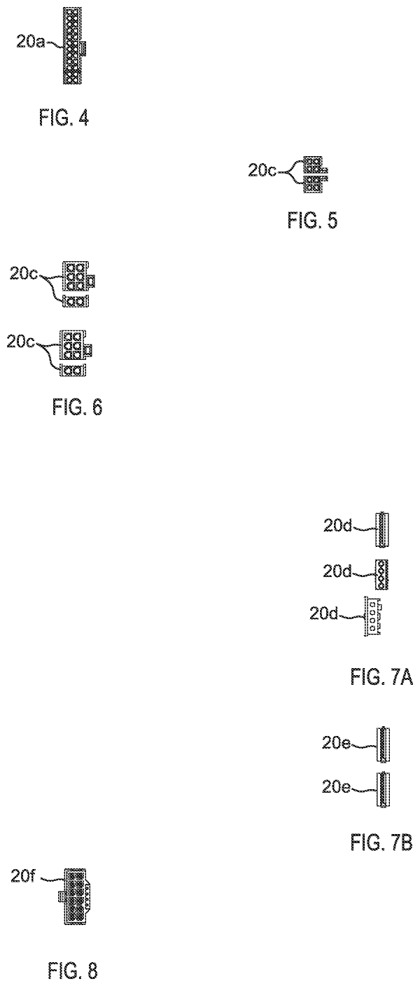

FIG. 4 is a left view of a 24P power connector for a computer motherboard in the embodiment of FIG. 1A. As shown in FIGS. 1A and 4, the first connector 20 is a 24P power connector 20a to be connected with the computer motherboard, and the number of the integrated wire harness 10 is 8 to 13. The total number of the integrated wire harness 10 will vary depending on the number of wires 11 surrounding the central wire 11a circumferentially. The more the wires 11 are arranged circumferentially, the fewer the total number of the integrated wire harness 10 are designed. On the contrary, the fewer the wires 11 are arranged circumferentially, the more the total number of the integrated wire harness 10 are designed.

FIG. 5 is a left view of a power connector for a central processing unit in the embodiment of FIG. 1B. As shown in FIGS. 1B and 5, the first connector 20 is a power connector 20b to be connected with the central processing unit, and the number of the integrated wire harness 10 is 1 to 4.

FIG. 6 is a left view of a power connector for a VGA card in the embodiment of FIG. 1 C. As shown in FIGS. 1C and 6, the first connector 20 is a power connector 20c to be connected with the VGA (Video Graphics Array) card, and the number of the integrated wire harness 10 is 1 to 8.

FIG. 7A is a left view of a power connector for a hard drive in the embodiment of FIG. 1D. FIG. 7B is a left view of a power connector for a hard drive in the embodiment of FIG. 1E. As shown in FIGS. 1D, 1E, 7A and 7B, the first connector 20 is a power connector 20d to be connected with the traditional hard drive or a power connector 20e to be connected with an alternative hard drive, and the number of the integrated wire harness 10 is 2 to 15.

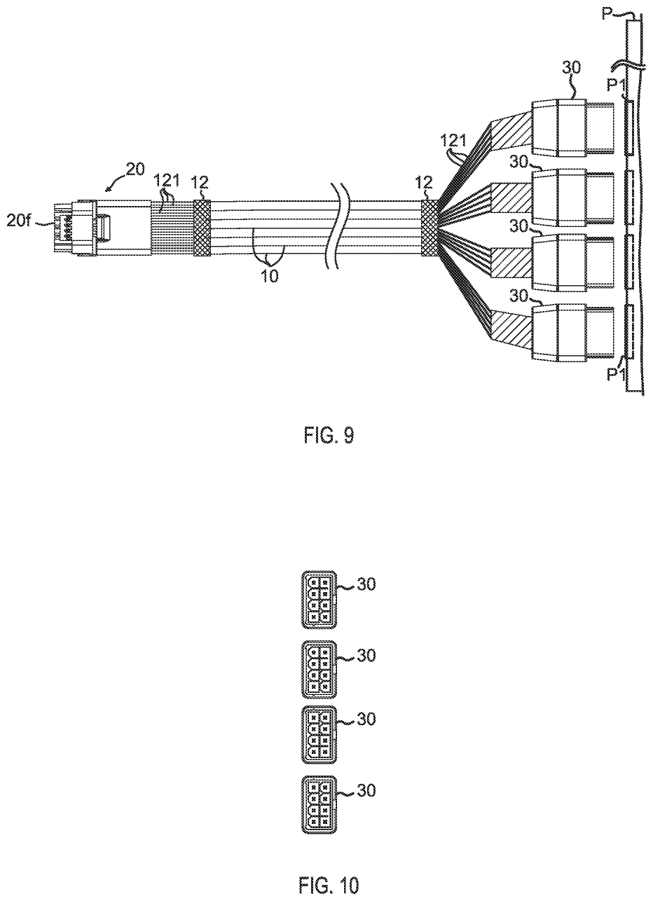

FIG. 8 is a left view of a 12+4P power connector for the PCIe (Peripheral Component Interconnect Express) 5.0 interface in the embodiment of FIG. 1F. FIG. 9 is a front view for another embodiment of an integrated power supply DC output line in accordance with the present invention. FIG. 10 is a right view of second connectors of the integrated power supply DC output line in FIG. 9. As shown in FIGS. 1F and 8, the first connector 20 is a 12+4P power connector 20f for the PCIe 5.0 interface. As shown in FIGS. 9 and 10, the power supply unit P in another embodiment includes at least an output module socket P1, the first ends 111 of the integrated wire harnesses 10 are respectively plugged into corresponding output module sockets P1 by a plurality of second connectors 30 (for example, four second connectors 30 for the embodiment in FIG. 9) for power receiving. The first connector 20 is a 12+4P power connector 20f for the PCIe 5.0 interface, and each of the second connectors 30 is an 8P power connector for the PCI interface.

It should be mentioned that the type of the second connector 30 is identical to or different from that of a corresponding first connector 20. In this embodiment of FIGS. 9 and 10, the integrated wire harness 10 is characteristic of a plurality of leading wires 121 stemming from wires 11 through a wire terminal 12 at the side of the second connector 30 and further connected with the second connectors 30.

In summary, the integrated power supply DC output line of the present invention is applicable to a host computer or an alternative functional host machine such that the number of integrated wiring harnesses inside the host computer is significantly reduced. Specifically, a conventional 24P motherboard power connector (at a 2328-pin wire harness), a conventional CPU power connector (at a 4˜16-pin wire harness), a conventional power connector (at a 6N-pin wire harness) and a conventional hard drive power connector (at a 4N-pin wire harness) are transformed to a 24P motherboard power connector (at a 8˜13-pin wire harness), a CPU power connector (at a 1˜4-pin wire harness), a VGA power connector (at a 1˜8-pin wire harness) and a hard drive power connector (at a 2˜15-pin wire harness) of the present invention, respectively. The integrated power supply DC output line of the present invention proves effective in economy of materials, material cost reduction, improvement of production efficiency and less space occupation inside a host computer for user-friendly and simplified cable management inside the host computer.

The scope of the invention is to be indicated by the appended claims, rather than by the foregoing description, and all changes which come within the meaning and range of equivalency of the claims are intended to be embraced therein.

1. An integrated power supply DC output line serving as a power output line of a power supply unit and comprising:
at least an integrated wire harness including spaced first and second ends, wherein the first end is connected with the power supply unit, and the second end is connected with a wire terminal from which the at least an integrated wire harness is transformed to a plurality of leading wires, with the integrated wire harness including an insulating layer at an outermost layer thereof and a plurality of wires within the insulating layer; and
a first connector electrically connected with the plurality of leading wires.

2. The integrated power supply DC output line as claimed in claim 1, wherein the plurality of wires includes a sheathed wire centrally inside the insulating layer and multiple unsheathed wires positioned between the insulating layer and the sheathed wire and based on equiangular arrangement around the sheathed wire circumferentially, wherein the sheathed wire is coated with a protective layer outside and has a wire diameter greater than a wire diameter of the unsheathed wire.

3. The integrated power supply DC output line as claimed in claim 1, wherein the plurality of wires includes a first unsheathed wire centrally inside the insulating layer, a plurality of sheathed wire positioned between the insulating layer and the first unsheathed wire, and multiple second unsheathed wires, wherein the plurality of sheathed wire are based on equiangular arrangement around the first unsheathed wire circumferentially, with each second unsheathed wire arranged between two adjacent sheathed wires and the insulating layer, wherein the sheathed wire is coated with a protective layer outside and has a wire diameter greater than a wire diameter of each of the first and second unsheathed wires.

4. The integrated power supply DC output line as claimed in claim 1, wherein the plurality of wires includes a plurality of sheathed wires positioned inside the insulating layer and arranged as a bundle, wherein each sheathed wire is coated with a protective layer outside.

5. The integrated power supply DC output line as claimed in claim 1, wherein the first end of the integrated wire harness is a power receiving terminal from which DC power input of the power supply unit is transmitted to the integrated wire harness, and the second end is a power transmitting terminal from which DC power output is transmitted to a facility connected with the second end.

6. The integrated power supply DC output line as claimed in claim 1, wherein the first end of the integrated wire harness is directly connected with internal circuits of the power supply unit for power receiving.

7. The integrated power supply DC output line as claimed in claim 1, wherein the first connector is a 24P power connector to be connected with a computer motherboard, and the at least an integrated wire harness includes 8 to 13 integrated wire harnesses.

8. The integrated power supply DC output line as claimed in claim 1, wherein the first connector is a power connector to be connected with a central processing unit, and the at least an integrated wire harness includes 1 to 4 integrated wire harnesses.

9. The integrated power supply DC output line as claimed in claim 1, wherein the first connector is a power connector to be connected with a VGA card, and the at least an integrated wire harness includes 1 to 8 integrated wire harnesses.

10. The integrated power supply DC output line as claimed in claim 1, wherein the first connector is a power connector to be connected with a hard drive, and the at least an integrated wire harness includes 2 to 15 integrated wire harnesses.

11. The integrated power supply DC output line as claimed in claim 1, wherein the first connector is a 12+4P power connector for a PCIe 5.0 interface.

12. The integrated power supply DC output line as claimed in claim 1, wherein the power supply unit includes at least an output module socket, and the first end of the integrated wire harness is plugged into the output module socket through a second connector for power receiving.

13. The integrated power supply DC output line as claimed in claim 12, wherein a type of the second connector is identic al to that of a corresponding first connector.

14. The integrated power supply DC output line as claimed in claim 11, wherein the power supply unit is equipped with a plurality of output module sockets, and the first end of the integrated wire harness is plugged into a corresponding output module socket for power receiving through a plurality of second connectors which are 8P connectors for the PCIe interface.
